(19) United States
(12) Patent Application Publication
(10) Pub. No.: US 2021/0102401 A1
(43) Pub. Date: Apr. 8, 2021

(54) DEADBOLT DOG

(71) Applicant: John Bradwell Stebbins, Atlantic Beach, FL (US)

(72) Inventor: John Bradwell Stebbins, Atlantic Beach, FL (US)

(21) Appl. No.: 16/590,488

(22) Filed: Oct. 2, 2019

(51) Int. Cl. E05B 13/04; E05B 13/00

(52) U.S. Cl. CPC E05B 13/04; E05B 13/002

(57) ABSTRACT

Viewing FIG. 4, In operation a person who is desirable to secure a 1 Deadbolt from outside access such as but not limited to a key, while still maintaining use interior would, Engage 1 Deadbolt by rotating 3 Deadbolt Cylinder Knob, grasp 10 DEADBOLT DOG and surround said 3 Deadbolt Cylinder Knob with said upper paw, then urge rotation of 10 DEADBOLT DOG in the direction of 6 Latch Bolt Knob Shaft while urging said lower paw to catch on and engaging a portion of the perimeter of said 6 Latch Bolt Knob Shaft. During an event wherein it is desirable to quickly allow normal operation of said 1 Deadbolt, a person would urge said lower paw to disconnect from said 6 Latch Bolt Knob Shaft by using hand or digit to urge said lower paw to disengage 10 DEADBOLT DOG.

### CROSS REFERENCE TO RELATED APPLICATIONS

This application claims the benefit of U.S. Provisional Application No. 62/726,210, filed 1 Sep. 2018, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

This invention relates generally to CLASS 70, LOCKS; more specifically to Subclass 416, Tampering prevention or attack defeating wherein the device includes mechanism to prevent tampering with the operating mechanism of a key lock or any static means designed to prevent attack by an unauthorized force; and CLASS 70, Subclass: 417, for static armor construction for key locks which prevent transmission of unauthorized force upon the exterior of the lock to disable the lock.

### PRIOR ART

A typical deadbolt is a lockable deadlock for face mounting, has a housing and an axially displaceable securing bolt mounted in the housing and moveable between a retracted position and an extended position, the deadbolt further comprising locking means to lock the bolt in at least the extended position and retaining means to retain the bolt in the housing.

My invention DEADBOLT DOG overcomes the problems associated with prior art devices such as but not limited to: U.S. Pat. No. 3,585,827 Dated: Jun. 22, 1971, and U.S. Pat. No. 4,279,137 Dated: Jul. 21, 1981, and U.S. Pat. No. 5,035,128 Dated: Jul. 30, 1991, and U.S. Pat. No. 6,993,944 Dated: Feb. 7, 2006, and U.S. Pat. No. 9,644,395 B2 Dated: May 9, 2009.

While Prior art listed contains many tiny intricate parts which are movable, adjustable, contain springs and requires some mechanical ability to use, as well as the need for various tools said prior art is cumbersome, large and difficult to remove before the lock can be unlocked.

Aforementioned prior art problems are overcome by my invention, DEADBOLT DOG, because DEADBOLT DOG is designed of a combination of rubber having different durity and steel having a high tensile strength, it is both shapeable and resist breakage.

### BRIEF SUMMARY OF THE INVENTION

In view of the foregoing background, it is therefore an object of the non-limiting exemplary embodiments to provide a brief summary of the invention; some of the advantages are one-piece design, small and convenient to use and provides instant deadbolt lock dogging. Embodiments described below demonstrate how said DEADBOLT DOG solves many of said prior art problems.

While my invention DEADBOLT DOG has the same intent as prior art, denying unwanted access, my scope is larger and encompasses the ease of removing DEADBOLT DOG as well as being compact in design and does not require additional tools to affix to said deadbolt assembly.

My invention DEADBOLT DOG is a solid one-piece design having a non-marring covering and is designed to be a blocking element, in the form of a pawl or catch, adapted to releasable detain a movable part.

While the aforementioned devices still provide a means to secure a deadbolt from exterior use, they were designed at a time when door specifications were not strictly enforced by building codes that dictate a standard in door hardware configuration and dimensions; in addition, City Fire Codes and Ordinance begin implementing Life Safety Plans. Due to said new fire codes, an easier less cumbersome device is required.

A common problem with deadbolt design is securing the inner deadbolt from the exterior key access and having said device be removed easily and quickly in the event of an emergency; or when trying to prevent unwanted entry during sleep or safety concerns such as but not limited to a disgruntled paramour gaining unwanted access or a neighbor with a key whom no longer has permission to gain entry.

These and other objects, features, and advantages of the invention are provided by description of the preferred embodiments.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE VIEW OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

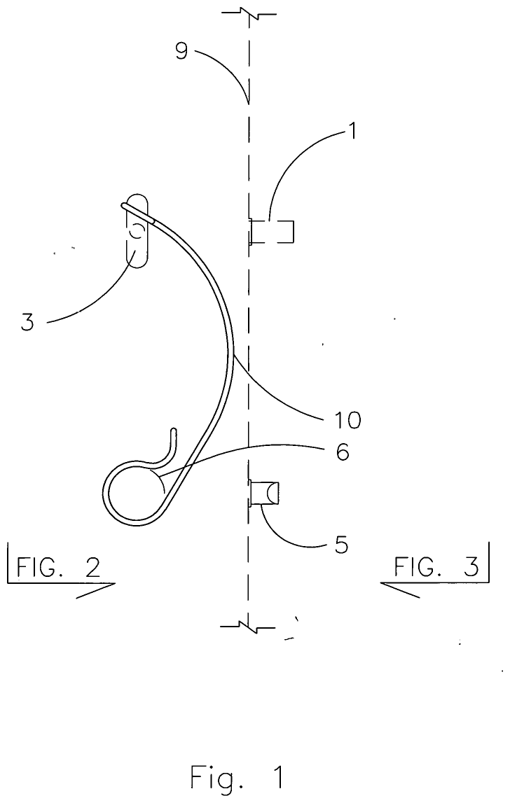

Viewing FIG. 1 the reader can see an interior view of a door 9 having a deadbolt 1 installed above a latch bolt 5 and in accordance with prior art, also having said DEADBOLT DOG 10 installed.

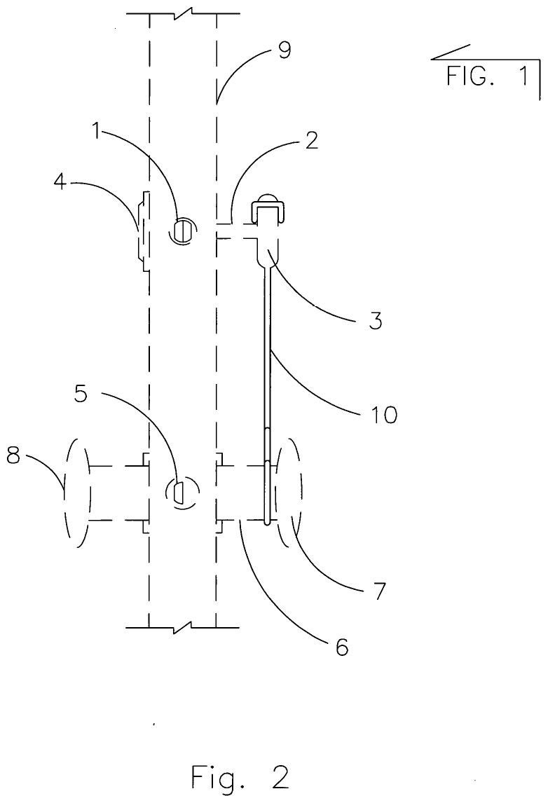

Viewing FIG. 2 the reader can see a typical side view of said 9 door having a deadbolt 1 installed above the latch bolt 5 and in accordance with prior art, also having said 10 DEADBOLT DOG installed.

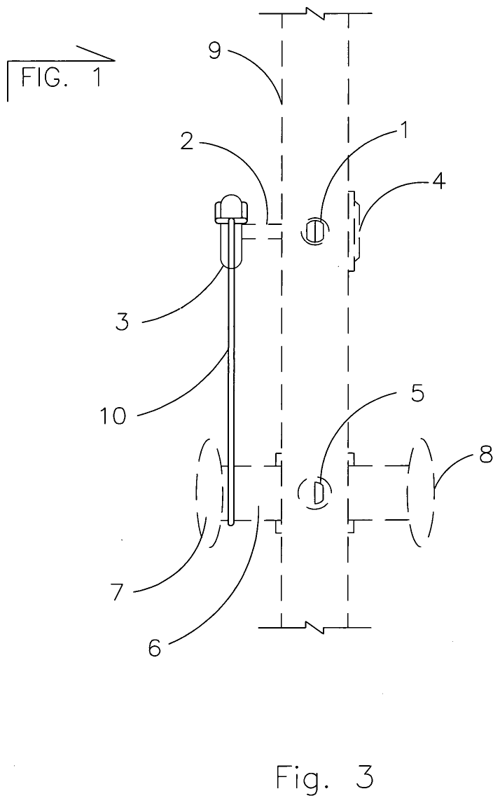

Viewing FIG. 3 the reader can see a typical alternate side view of said door 9 having a deadbolt 1 installed above the latch bolt 5 and in accordance with prior art, also having said DEADBOLT DOG 10 installed.

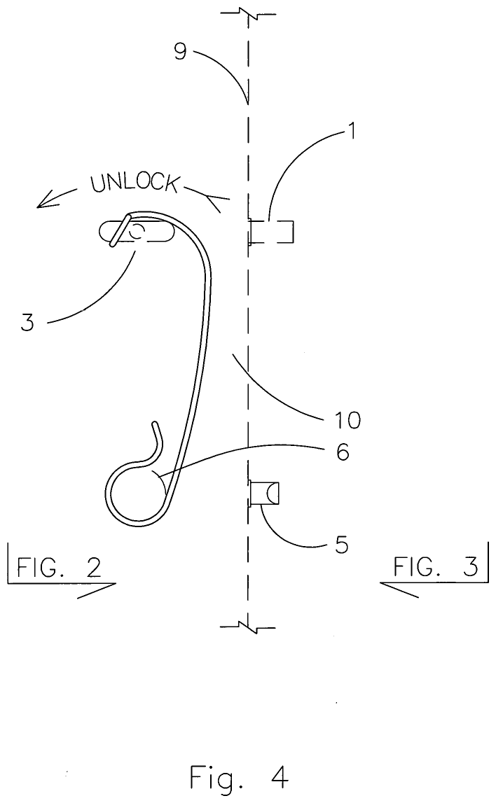

Viewing FIG. 4 the reader can see an alternative dogging of a deadbolt cylinder knob that operates rotated 90 degrees.

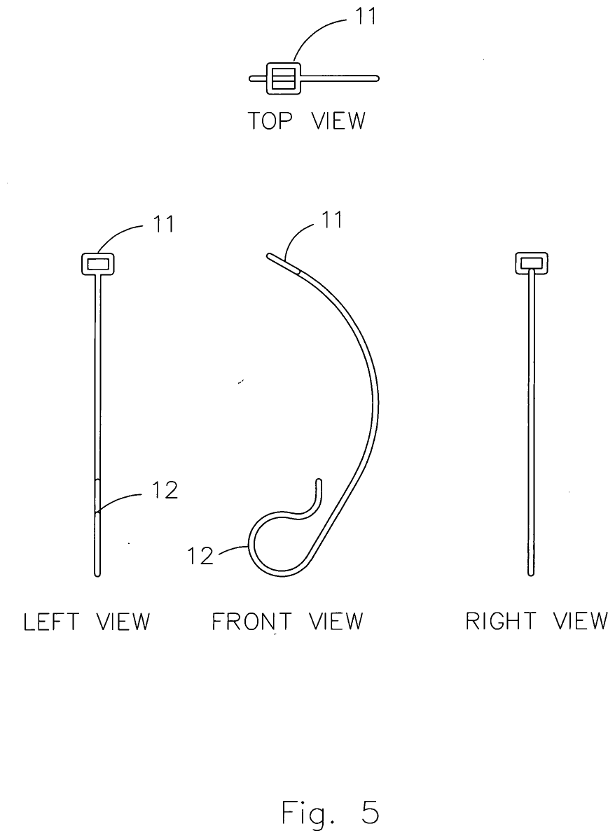

Viewing FIG. 5 the reader can see a front view, a left view, a right view and a top view of said DEADBOLT DOG 10, additionally viewing latch bolt knob shaft paw 12 and deadbolt cylinder knob paw 11.

Deadbolt dog is designed to have an upper end and a lower end. Said upper end has a deadbolt cylinder knob paw 11 designed for engaging said deadbolt cylinder knob 3. Said lower end has a latch bolt knob shaft paw 12 designed for engaging a portion of the perimeter of said Latch Bolt Knob Shaft 6. Additionally, said upper end and said lower end are connected by a synergist covering resulting in higher tensile strength and spring resistance.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The non-limiting exemplary embodiments will now be described more fully hereinafter with reference to the accompanying drawings, in which a preferred embodiment of the invention is shown. This invention may, however, be embodied in many different forms and should not be construed as limited to the embodiment set forth herein. Rather, these embodiments are provided so that this application will be thorough and complete, and will fully convey the true scope of the invention to those skilled in the art. Like numbers refer to like elements throughout the figures.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “non-limiting exemplary embodiments” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the non-limiting exemplary embodiments. Thus, to the maximum extent allowed by law, the scope of the non-limiting exemplary embodiments is to be determined by the broadest permissible interpretation of the following claims and their equivalents, and shall not be restricted or limited by the foregoing detailed description.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “non-limiting exemplary embodiment” in various places in the specification are not necessarily all meant to refer to the same embodiment.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The apparatus of this invention is referred to generally in FIG. 1 intends to provide a view of DEADBOLT DOG. It should be understood that the non-limiting exemplary embodiments may be used to describe similar apparatus and many different types of devices and should not be limited to the uses described herein. The descriptor nomenclature legend that follows is not meant to be all encompassing but to aid the reader in understanding the figures within the drawings.

Included to aid the reader in understanding the unique and novel design and use of said invention DEADBOLT DOG are 5 drawings; FIG. 1 showing the DEADBOLT DOG as viewed from interior; and FIG. 2 side view; and FIG. 3 alternate side view of a door having a deadbolt; and Fig. an alternative dogging of a deadbolt cylinder knob which operates rotated 90 degrees and FIG. 5 My invention DEADBOLT DOG.

Also an item description is disclosed:
1. Deadbolt, and
2. Deadbolt interior knob shaft, and
3. Deadbolt cylinder knob, and
4. Deadbolt cylinder keyed, and
5. Latch bolt, and
6. Latch bolt knob shaft, and
7. Interior latch bolt cylinder knob, and
8. Exterior latch bolt cylinder knob, and
9. Door, and
10. DEADBOLT DOG, and
11. Deadbolt cylinder knob paw, and
12. Latch bolt knob shaft paw.

Viewing FIG. 1 of said invention DEADBOLT DOG is constructed from such as but not limited to a dense, vibration absorbing material, of structurally complementary substances, especially a chemical composition with physical and thermal properties, combined to produce structural and functional properties not present in any individual component thereby having a solid one-piece design capable of instantly dogging the operation a deadbolt lock cylinder knob.

While the invention has been described with respect to certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the non-limiting exemplary embodiments may include variations in size, materials, shape, form, function and manner of operation.

1. A DEADBOLT DOG comprising:
of a solid one piece design having a non-marring covering and is designed to be a instant blocking element in the form of a pawl or catch, adapted to releasable detain a deadbolt lock cylinder knob and operation.

2. The DEADBOLT DOG of claim 1, further comprises:
A deadbolt cylinder dogging device which is attachable and operable to a deadbolt cylinder knob without tools.

3. The DEADBOLT DOG of claim 1, further comprising:
A deadbolt cylinder dogging device which is removable without tools.
